(19) United States
(12) Patent Application Publication
(10) Pub. No.: US 2024/0224150 A1
(43) Pub. Date: Jul. 4, 2024

(54) HANDOVER INFORMATION REPORTING METHOD AND USER EQUIPMENT

(71) Applicant: SHARP KABUSHIKI KAISHA, Sakai City, Osaka (JP)

(72) Inventors: NINGJUAN CHANG, Shanghai (CN); RENMAO LIU, Shanghai (CN)

(21) Appl. No.: 18/292,320

(22) PCT Filed: Jul. 27, 2022
(86) PCT No.: PCT/CN2022/108213

§ 371 Date: Jan. 25, 2024

(30) Foreign Application Priority Data
Jul. 29, 2021 (CN) 202110867601.2

(51) Int. Cl. H04W 36/30; H04W 36/00; H04W 36/36

(52) U.S. Cl. CPC H04W 36/305; H04W 36/00837; H04W 36/362

(57) ABSTRACT

Provided in the present disclosure are a handover information reporting method and user equipment. The handover information reporting method includes: performing, by user equipment (UE), a legacy handover procedure; if the UE is configured with a conditional handover (CHO), setting, by the UE according to whether a target cell of a handover is a candidate cell in a CHO configuration stored by the UE, first time information in a successful handover report (SHR) when the handover succeeds or second time information in a radio link failure report (RLF-report) when the handover fails; and if the target cell of the handover is a candidate cell in the CHO configuration stored by the UE, setting the first time information or the second time information to be: the time elapsed between the UE receiving a corresponding latest CHO configuration including the candidate cell and the UE starting to perform the handover, wherein the legacy handover procedure is a handover procedure performed by the UE by immediately applying a configuration in a handover command upon receiving the handover command.

### TECHNICAL FIELD

The present disclosure relates to the technical field of wireless communications. More specifically, the present disclosure relates to a handover information reporting method in the case of a handover and corresponding user equipment.

### BACKGROUND

A new research project on Release 17 technology standards (see non-patent literature: RP-193255: New WID on enhancement of data collection for SON/MDT in NR) was approved in the 3rd Generation Partnership Project (3GPP) RAN #86 plenary session held in December 2019. The research objective of this project is to enhance a network data collection procedure in an NR system so as to better achieve the objective of a self-organization, self-optimization network and minimization of drive tests. One of the specific techniques of the research is to implement handover information reporting in a successful handover scenario and link failure information reporting in a conditional handover scenario.

The present disclosure provides a solution to the issue of how to implement handover information reporting and link failure information reporting in an NR system.

### SUMMARY

An objective of embodiments of the present disclosure is to provide a solution to the issue of how to implement handover information reporting in an NR system. More specifically, the present disclosure provides a solution to the issue of how to record handover information in an NR system when UE is configured with a conditional handover (CHO). Provided in the embodiments of the present disclosure are a handover information reporting method performed in user equipment, corresponding user equipment, and a communication system.

According to a first aspect of the present disclosure, provided is a handover information reporting method, comprising: performing, by user equipment (UE), a legacy handover procedure; if the UE is configured with a conditional handover (CHO), setting, by the UE according to whether a target cell of a handover is a candidate cell in a CHO configuration stored by the UE, first time information in a successful handover report (SHR) when the handover succeeds or second time information in a radio link failure report (RLF-report) when the handover fails; and if the target cell of the handover is a candidate cell in the CHO configuration stored by the UE, setting the first time information or the second time information to be: the time elapsed between the UE receiving a corresponding latest CHO configuration comprising the candidate cell and the UE starting to perform the handover, wherein the legacy handover procedure is a handover procedure performed by the UE by immediately applying a configuration in a handover command upon receiving the handover command.

In the handover information reporting method according to the first aspect, if the target cell of the handover is not a candidate cell in the CHO configuration stored by the UE, when the handover succeeds, the first time information is set to be: the time elapsed between the UE receiving a latest CHO configuration and the UE starting to perform the handover; when the handover fails, the second time information is set to be: the time elapsed between the UE receiving the latest CHO configuration and the UE starting to perform the handover.

In the handover information reporting method according to the first aspect, if the target cell of the handover is not a candidate cell in the CHO configuration stored by the UE, when the handover succeeds, the first time information is set to be: the time elapsed between the UE receiving the latest CHO configuration comprising a candidate cell having the best signal quality and the UE starting to perform the handover; when the handover fails, the second time information is set to be: the time elapsed between the UE receiving the latest CHO configuration comprising a candidate cell having the best signal quality and the UE starting to perform the handover.

In the handover information reporting method according to the first aspect, if the target cell of the handover is not a candidate cell in the CHO configuration stored by the UE, when the handover succeeds, the UE does not record the first time information, and when the handover fails, the UE does not record the second time information.

In the handover information reporting method according to the first aspect, the candidate cell having the best signal quality is the candidate cell having the best measurement result among configured conditional handover candidate cells, and the measurement result may be a measurement result of reference signal receiving power (RSRP), reference signal receiving quality (RSRQ), a signal to interference plus noise ratio (SINR), or a received signal strength indication (RSSI) for representing link quality.

In the handover information reporting method according to the first aspect, the target cell of the handover being a candidate cell in the CHO configuration stored by the UE can be expressed as: a cell identifier of the target cell is identical to a cell identifier of a candidate cell comprised in a synchronized reconfiguration information element reconfigurationWithSync in a MasterCellGroup information element in a stored conditional reconfiguration variable VarConditionalReconfig.

According to a second aspect of the present disclosure, provided is a handover information reporting method, comprising: user equipment (UE) detecting a radio link failure (RLF); if the UE is configured with a conditional handover (CHO), setting, by the UE, second time information in a radio link failure report (RLF-report) to any one of the following information: the time elapsed between the UE receiving a latest CHO configuration and the UE detecting the RLF; the time elapsed between the UE receiving a latest CHO configuration comprising a candidate cell having the best signal quality and the UE detecting the RLF; and skipping, by the UE, recording of the second time information.

According to a third aspect of the present disclosure, provided is user equipment (UE), comprising: a processor; and a memory storing instructions, wherein the instructions, when run by the processor, perform the handover information reporting method described herein.

### BRIEF DESCRIPTION OF THE DRAWINGS

In order to understand the present disclosure and advantages thereof more fully, reference will now be made to the following description made in conjunction with the accompanying drawings:

FIG. 1 is a schematic diagram showing a general handover procedure.

FIG. 2 is a flowchart showing a handover information reporting method according to Embodiment 1 of the present disclosure.

FIG. 3 is a block diagram showing user equipment (UE) according to the present disclosure.

In the drawings, identical or similar structures are marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion without limitation; the term “or” has an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of known functions and structures is omitted for clarity and simplicity. In addition, the same reference numerals are used for similar functions and operations throughout the accompanying drawings.

A plurality of embodiments according to the present disclosure are specifically described below by using a Long Term Evolution (LTE)/NR mobile communication system and subsequent evolved versions thereof as an exemplary application environment. However, it is to be noted that the present disclosure is not limited to the following embodiments, but is applicable to other wireless communications systems. In the present disclosure, unless otherwise specified, the concept of a cell and the concept of a base station are interchangeable. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). In the present disclosure, a handover refers to change of a primary cell initiated by a network side, the change including inter-cell change of the primary cell, and also including intra-cell change of the primary cell, that is, a primary cell of UE is changed from a source cell to a target cell, where the source cell and the target cell may be the same cell or different cells. In this procedure, a security key or keys or a security algorithm for access layer security may also be accordingly updated. The security includes encryption and decryption and integrity protection. The source cell may also be referred to as a source base station, or a source beam, a source transmission point (TRP), a source primary cell (PCell), or a source master cell group (MCG), and the target cell may also be referred to as a target base station, or a target beam, a target transmission point, a target primary cell (PCell), or a target master cell group (MCG). The source cell refers to a cell connected to and serving the UE before a handover procedure is initiated, namely, a cell transmitting to the UE a radio resource control (RRC) message including a handover command. The target cell refers to a cell connected to and serving the UE after the handover procedure is successfully completed, or a cell indicated by a target cell identifier included in the handover command, or a cell that performs downlink synchronization and random access in the handover procedure. The handover of the present disclosure may also refer to a change in the primary secondary cell (PSCell), and in this case, handover information or a handover report refers to handover information or a handover report related to the PSCell. The handover command described in the present disclosure is used to trigger the UE to execute a handover. In an NR system, the handover command is an RRC reconfiguration message including a synchronized reconfiguration (Reconfigurationwithsync) information element, or rather, the handover command is an RRC reconfiguration message including a synchronized reconfiguration (Reconfigurationwithsync) information element for a master cell group (MCG). In this case, the handover may also be referred to as an MCG synchronized reconfiguration. In an LTE system, the handover command is an RRC connection reconfiguration message including a mobility control information (MobilityControllnfo) information element. The synchronized reconfiguration information element or the mobility control information information element may include configuration information of the target cell, for example, a target cell identifier, a target cell frequency, common configurations of the target cell such as system information, a random access configuration used by the UE to access the target cell, a security parameter configuration of the UE in the target cell, a radio bearer configuration of the UE in the target cell, and the like. For simplicity of description, in the present disclosure, the RRC reconfiguration message is equivalent to the RRC connection reconfiguration message; similarly, an RRC reconfiguration complete message serving as a response message thereto is equivalent to an RRC connection reconfiguration complete message. The handover command is equivalent to an RRC message including the handover command, and refers to an RRC message or a configuration in the RRC message triggering the UE to execute a handover. The handover configuration refers to all of or part of configurations in the handover command. “Cancel”, “release”, “delete”, “flush”, and “remove” are interchangeable. “Execute”, “use”, and “apply” are interchangeable. “Configure” and “reconfigure” are interchangeable. “Monitor” and “detect” are interchangeable. An RRC re-establishment message is equivalent to an RRC connection re-establishment message; similarly, an RRC re-establishment complete message serving as a response message thereto is equivalent to an RRC connection re-establishment complete message.

The following describes processes or concepts in the prior art to which the present disclosure relates.

Handover configuration in NR system:

In an NR system, an RRC reconfiguration message for a handover command carries RRC configurations from a target base station, including but not limited to the following RRC configurations (see Section 6.2.2 of 3GPP Technical Standard Protocol 38.331 for details):
A measurement configuration (measconfig information element): used to configure intra-frequency, inter-frequency, and inter-radio access technology measurements performed by UE, for example, a measurement object configuration, a measurement report configuration, a measurement gap configuration, etc.
A cell group configuration (cellGroupConfig information element), used to configure a master cell group or a secondary cell group, including a Radio Link Control (RLC) bearer configuration (an rlc-bearerToAddModList information element and an rlc-bearerToreleaselist information element), a Medium Access Control (MAC) configuration (a MAC-cellgroupconfig information element), a physical layer configuration, a secondary cell addition/modification/release configuration, a special cell (SpCell) configuration, etc., corresponding to a data radio bearer/signaling radio bearer. The sPCell configuration includes a cell index number, handover information (reconfigurationWithSync information element), a radio link failure-related timer and constant configuration, a Radio Link Monitoring (RLM) configuration, a special cell dedicated configuration, etc. The reconfigurationwithsync information element is similar to the mobility control information in the LTE system and includes handover-related information to implement mobility, and said information includes serving cell configuration common information, a cell radio network temporary identifier (C-RNTI) of the UE in the target cell, configurations of a handover procedure monitoring timer T304, a random access dedicated configuration for a random access procedure to the target cell.
Non-access stratum dedicated information (dedicatedInfoNASList information element).
A radio bearer configuration (radiobearerConfig information element), used to configure a Service Data Application Protocol layer (SDAP) and a Packet Data Convergence Protocol layer (PDCP) of a Data Radio Bearer (DRB) and/or a Signaling Radio Bearer (SRB).
A master key update configuration (masterKeyupdate information element).

Handover procedure in NR system:

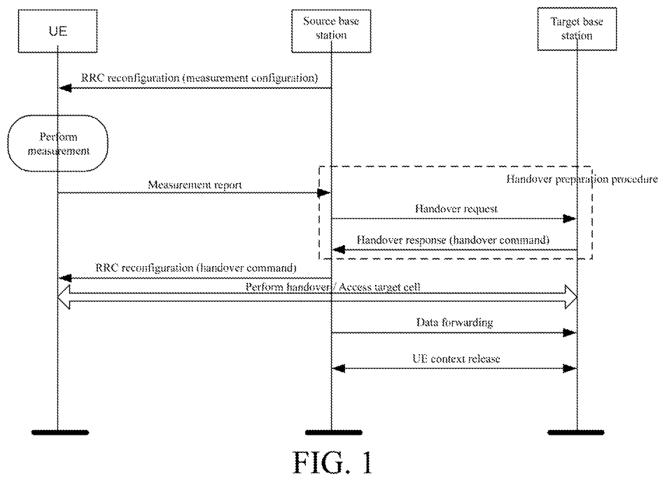

User mobility in a connected state is implemented mainly by means of a handover procedure, and the handover refers to a procedure in which UE in an RRC connected state changes a serving cell (primary cell). FIG. 1 is a schematic diagram showing a general handover procedure. As shown in FIG. 1, a general handover procedure includes the following phases: in phase 1, a measurement phase, UE measures, on the basis of a configured measurement configuration, a radio link corresponding to a serving cell or a neighboring cell. When a configured measurement reporting condition is met, the UE transmits a measurement report to a base station. In phase 2, a handover preparation phase, the base station determines, in view of the received measurement report and other factors such as the load of the base station, to trigger a handover for the UE. A source base station and a target base station acquire, by means of a handover preparation procedure, a handover command configured by the target base station. In phase 3, a handover execution phase, the source base station issues the handover command to the UE, and the UE receiving the handover command immediately applies a configuration of the handover command to perform the handover. The UE detects a handover procedure by using a timer T304. When the handover procedure is initiated, the UE starts the timer T304. When the handover procedure is completed, the UE stops the timer T304. When T304 expires, the UE considers that the handover fails.

The NR system further supports a conditional handover (CHO) that is also referred to as a conditional reconfiguration, which is different from the general handover procedure in which the UE immediately performs the handover after receiving the handover command in phase 3. In the conditional handover, a relatively conservative measurement report threshold is set, so that a base station acquires a measurement result in advance, and performs handover preparation with a selected target base station in advance according to the measurement result. In this case, the base station can issue a handover command including a handover candidate cell and a handover execution condition to UE before an actual handover condition (relative to the conservative measurement report threshold) is met, wherein the handover command carries a condition for executing a handover by the UE. After receiving the conditional handover command, the UE will not execute a handover immediately but stores a received handover command configuration, and starts to monitor the link quality of a source cell or the link quality of a target cell according to the handover execution condition carried in the handover command message, so as to evaluate whether the handover execution condition is met. Only when it is determined, by means of monitoring, that the configured handover execution condition is met, does the UE start to execute the stored handover command and access the target cell. The UE may be simultaneously configured with a plurality of conditional handover candidate cells. If the plurality of conditional handover candidate cells all meet the handover execution condition, then the UE selects a candidate cell therefrom as a final conditional handover target cell, and performs the handover to the cell. In summary, the conditional handover refers to a handover procedure that is executed only when one or more configured handover execution conditions are met. Because the handover command is included in the RRC reconfiguration message, the conditional handover is also referred to as a conditional reconfiguration. In the NR system, after the UE receives an RRC reconfiguration message including the conditional handover command (a ConditionalReconfiguration information element), the conditional handover command including a conditional reconfiguration candidate cell list (a condReconfigToAddModList information element), the UE stores configurations corresponding to the conditional reconfiguration candidate cells in a UE variable VarConditionalReconfig, which includes a plurality of items. Each item is identified by a conditional reconfiguration identity (condReconfigId), and includes an execution condition (condExecutionCond) and a target cell handover configuration (condRRCReconfig). A cell identified by a cell identifier in a serving cell common configuration (a servingCellConfigCommon information element) in a synchronized reconfiguration (a reconfigurationWithSync information element) in the target cell handover configuration corresponds to a conditional reconfiguration candidate cell. The UE performs conditional reconfiguration evaluation on each conditional reconfiguration candidate cell according to the execution condition. The execution condition may include one or two measurement identities (measID). Only when all measurement events (condEventA3 or CondEventA5 included in a CondTriggerConfig information element) corresponding to all measurement identities included in the execution condition are met, the UE considers that the corresponding candidate cell is a triggering cell, and initiates a conditional reconfiguration execution procedure. In the conditional reconfiguration execution procedure, the UE applies, to the selected triggering cell, a stored handover configuration (condRRCReconfig) corresponding to the cell, performs a cell handover operation, such as starting the timer T304, performs downlink synchronization to the target cell, initiates a random access procedure to the target cell to perform uplink synchronization, transmits an RRC reconfiguration complete message to the target cell, and so on (see section 5.3.5.3 of 3GPP protocol specification document TS38.331 for details, which will not be described herein again). The conditional reconfigurations and the conditional handover configurations are interchangeable. The conditional handover configurations refer to the above configurations related to the conditional handover, and may also refer to an RRC reconfiguration message including these configurations.

In the present disclosure, if handover procedures (procedures for applying and executing RRC reconfigurations) are not performed because of a CHO, said procedures are collectively referred to as legacy handovers, i.e., non-CHO handovers. The CHO refers to a conditional reconfiguration for an MCG.

Successful handover report:

As previously described, one of the objectives of the new research project of Release 17 is to introduce handover information reporting in the case of a successful handover. The handover information reporting for a successful handover is also referred to as a successful handover report (SHR) for short. This is because, in an NR system, performing network optimization by relying only on a radio link failure (RLF) report in an existing mechanism may cause a data acquisition process to become lengthened, and handover information reporting, when a handover succeeds, enables the network side to acquire a sufficient number of samples in a mobility procedure more quickly. Second, even for a successful handover scenario, a mobility parameter thereof also needs to be further optimized. The content of successful handover information reporting may include one or a plurality of the following: a source cell identifier; a target cell identifier; measurement results for a source cell or target cell; measurement results for a neighbor cell; an RLF monitoring situation when a handover command is received or when a handover is performed, such as indicating the cause of the successful handover information reporting being triggered (that is, which triggering condition is met), a running situation of T310/T312 (indicating whether T310 and/or T312 exceeds a configured threshold), an RLC retransmission status, etc.; a beam failure monitoring situation when a handover command is received; one or more optimal beam identifiers of the downlink when random access to the target base station is performed; a running status/value of the timer T304 when a handover is successfully completed; random access procedure information; CHO candidate cell information (a measurement result or a cell identifier); an indication that a source cell detects an RLF in a dual active protocol stack (DAPS) handover procedure, and the like. The successful handover means that an RRC reconfiguration complete message for responding to a handover command RRC reconfiguration message with respect to the target base station has been successfully transmitted, or that a random access procedure to the target base station has been successfully completed at a MAC layer. The network side needs to configure, to the UE, a triggering condition of the successful handover information reporting. The UE will record handover information of the successful handover only when the configured one or more triggering conditions are satisfied. In the present conclusion of the 3GPP, the UE may inform, by using an RRC message, the network side that available successful handover information (for example, indicated by a SuccHORep-Available information element) is present thereon. After receiving the indication, the network side may request, by using an RRC message (for example, indicated by SuccessfulHOReportReq in a UEInformationRequest message), the UE to report the successful handover information report stored thereby. The UE will report the stored radio link failure report (SuccessfulHOReport in the UEInformationResponse message) to the network side in a response RRC message.

Link failure information reporting mechanism:

In a current LTE system and a current NR system of Release 16, UE will generate and store a radio link failure report (RLF report) when a radio link failure (RLF) or handover failure (HOF) is detected, and store radio link failure information in a UE variable VarRLF-Report. After a connection to a network side (e.g., through an RRC re-establishment procedure or an RRC establishment procedure for establishing a new connection) is recovered, the UE can inform, by means of an RRC message, the network side that there is an available radio link failure report thereon (indicated by an rlf-InfoAvailable information element). For example, the UE can inform the network side that the UE has the stored available radio link failure report in an RRC connection re-establishment complete message (RRCConnectionReestablishmentComplete) in an RRC connection re-establishment procedure, in an RRC connection re-configuration complete message (RRCConnectionReconfigurationComplete) in an RRC connection re-configuration procedure, in an RRC connection setup complete message (RRCConnectionSetupComplete) in an RRC connection setup procedure, or in an RRC connection resume complete message (RRCConnectionResumeComplete) in an RRC connection resumption procedure. After receiving the indication, the network side may request, by using an RRC message (an rlf-ReportReq information element in a UEInformationRequest message for indicating the request), the UE to report the radio link failure report stored thereby. The UE will report the stored radio link failure report (the rlf-Report information element in the UEInformationResponse message) to the network side in a response RRC message. The radio link failure report obtained by the network side is used for network optimization, such as network coverage and mobility robustness optimization. The radio link failure report may include: measurement results of a source cell and a neighboring cell available during link failure, location information, the identifier of a primary cell that detected the link failure, the type of the link failure (RLF or HOF), an RLF cause, the time elapsed between the connection failure and radio link failure reporting, the time elapsed between reception of a last handover command and the connection failure (recorded as a timeConnFailure information element), the identifier of a cell for the UE to re-access the network, i.e., an RRC re-establishment cell identifier, etc. In the current discussion of Release 17, for a scenario in which an HOF is detected when a CHO is performed, UE needs to record, in a corresponding RLF-report, the time elapsed between the time when a CHO procedure is performed and the corresponding time when a CHO configuration corresponding to a selected CHO candidate cell is received. Learning of the time information by the network side facilitates adjustment to an issuing occasion of the CHO configuration, thereby improving the robustness of the conditional handover.

For SHR in scenarios in which the CHO is configured, two scenarios are included: scenario 1: UE configured with the CHO has successfully performed a CHO procedure to a candidate cell. Scenario 2: before an execution condition of a candidate cell is satisfied, that is, before a CHO procedure is performed, UE configured with the CHO has received a legacy handover command, and the UE has successfully performed the handover procedure. Regarding scenario 1, in the currently reached conclusion of RAN2, UE includes, in SHR, time-related information that records the time elapsed between the UE starting to perform a CHO procedure to a target candidate cell and the UE receiving a corresponding latest CHO configuration including the target candidate cell. In scenario 2, UE is configured with the CHO, but has not performed a CHO procedure, and how to record the time elapsed between the UE receiving the CHO configuration and the handover procedure being performed has become a concern of the present disclosure.

Likewise, for RLF-report in scenarios in which the CHO is configured, some scenarios are also present: scenario 3: UE is configured with the CHO, but an RLF of a source cell is detected before a CHO execution(s) condition is satisfied, that is, before a CHO is triggered. Scenario 4: UE is configured with the CHO, but the UE receives a legacy handover command before a CHO execution(s) condition is satisfied, that is, before a CHO is triggered; however, a handover procedure triggered by the legacy handover command fails, or an RLF is detected in a target cell shortly after the handover procedure is successfully completed. Thus, in these scenarios, the UE is configured with the CHO, but has not performed a CHO procedure, and how to record the time elapsed from the UE receiving the CHO configuration to the handover procedure being performed or to the detection of the RLF is also a problem to be solved by the present disclosure.

The following embodiments provide a solution on the basis of the above problems. If not otherwise specified, some concepts or definitions are universally applicable among the embodiments. If not otherwise specified, the handover information report in the following embodiments of the present disclosure includes a successful handover report (SHR) in a successful handover scenario and a radio link failure report (RLF-report) in a handover failure or radio link failure scenario.

### Embodiment 1

This embodiment provides a handover information reporting method performed on UE. By means of the method according to this embodiment, in handover information reporting in which UE is configured with a CHO but a CHO procedure has not been performed, the UE may determine, according to whether a target cell of the handover is a candidate cell in a CHO configuration stored thereby, to set time information related to the CHO to be a corresponding value, so as to provide more precise handover information to the network side.

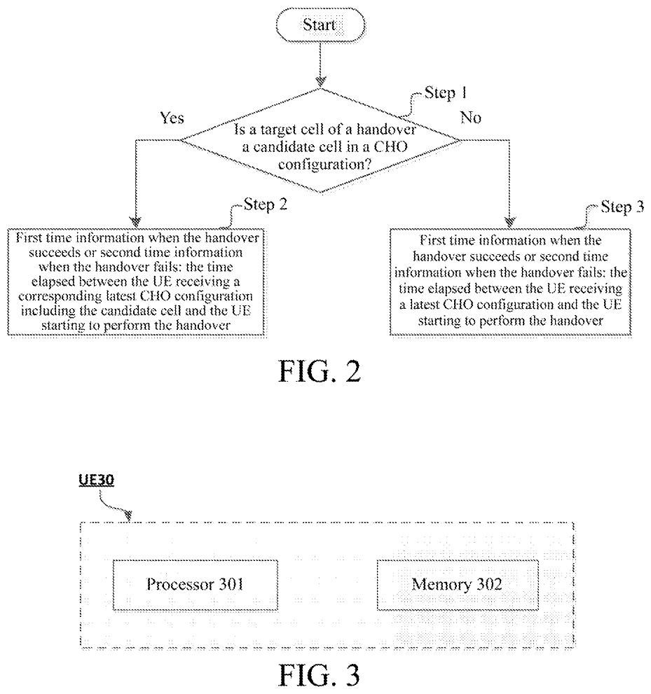

As an example, FIG. 2 is a flowchart showing a handover information reporting method according to Embodiment 1 of the present disclosure.

For a successful handover scenario, if UE is configured with a CHO, the value of first time information in an SHR is set by the UE according to the following method:
in step 1, the UE determines whether a target cell of a handover procedure is a candidate cell in a CHO configuration VarConditionalReconfig stored thereby, and if the target cell of the handover procedure is a candidate cell in the CHO configuration VarConditionalReconfig stored thereby, the UE enters step 2; in step 2, the UE sets the first time information to be the time elapsed between the UE receiving a corresponding latest CHO configuration including the candidate cell and the UE starting to perform the handover; if the target cell of the handover procedure is not a candidate cell in the CHO configuration VarConditionalReconfig stored by the UE, the UE enters step 3; and in step 3, the UE sets the first time information to be the time elapsed between the UE receiving a latest CHO configuration and the UE starting to perform the handover.

Optionally, in step 2, the corresponding latest CHO configuration including the candidate cell is not used to release the CHO configuration of the candidate cell. That is, in the corresponding latest CHO configuration including the candidate cell, a CHO configuration identifier CondReconfigId corresponding to the candidate cell is not included in a conditional reconfiguration release list condReconfigToRemoveList. Alternatively, in the corresponding latest CHO configuration including the candidate cell, the CHO configuration identifier CondReconfigId corresponding to the candidate cell is included in a conditional reconfiguration addition and modification list condReconfigToAddModList.

Optionally, in step 3, the latest CHO configuration is not a CHO configuration that only includes condReconfigToRemoveList. That is, the latest CHO configuration includes at least the conditional reconfiguration addition and modification list condReconfigToAddModList.

Preferably, when the above method of setting the first time information is used in scenario 2 described above, before the UE sets the time information, the method further includes determining, by the UE, that the handover is not performed due to execution of a CHO. That is, the handover is a legacy handover.

For a handover failure scenario, if UE is configured with a CHO, the value of second time information in RLF-report is set by the UE according to the following method:

In step 1, the UE determines whether a target cell of a handover procedure is a candidate cell in a CHO configuration VarConditionalReconfig stored thereby, and if the target cell of the handover procedure is a candidate cell in the CHO configuration VarConditionalReconfig stored thereby, the UE enters step 2; in step 2, the UE sets the second time information to be the time elapsed between the UE receiving a corresponding latest CHO configuration including the candidate cell and the UE starting to perform the handover; if the target cell of the handover procedure is not a candidate cell in the CHO configuration VarConditionalReconfig stored by the UE, the UE enters step 3; and in step 3, the UE sets the second time information to be the time elapsed between the UE receiving a latest CHO configuration and the UE starting to perform the handover.

Optionally, in step 2, the corresponding latest CHO configuration including the candidate cell is not used to release the CHO configuration of the candidate cell. That is, in the corresponding latest CHO configuration including the candidate cell, a CHO configuration identifier CondReconfigId corresponding to the candidate cell is not included in a conditional reconfiguration release list condReconfigToRemoveList. Alternatively, in the corresponding latest CHO configuration including the candidate cell, the CHO configuration identifier CondReconfigId corresponding to the candidate cell is included in a conditional reconfiguration addition and modification list condReconfigToAddModList.

Optionally, in step 3, the latest CHO configuration is not a CHO configuration that only includes condReconfigToRemoveList. That is, the latest CHO configuration includes at least the conditional reconfiguration addition and modification list condReconfigToAddModList.

Preferably, when the above method of setting the second time information is applicable to scenario 4 described above, before the UE sets the time information, the method further includes determining, by the UE, that the handover is not performed due to execution of a CHO. That is, the handover is a legacy handover.

For a radio link failure scenario (e.g., scenario 3 described above), if UE is configured with a CHO, the value of second time information in RLF-report is set by the UE according to the following method:
setting, by the UE, the second time information to be the time elapsed between the UE receiving the latest CHO configuration and the UE detecting the RLF.

The UE being configured with a CHO may also be expressed as the UE having a stored CHO configuration. The target cell of the handover being one among conditional handover candidate cells means that a cell identifier of the target cell is identical to a cell identifier of a candidate cell included in a synchronized reconfiguration information element reconfigurationWithSync in a MasterCellGroup information element in a stored conditional reconfiguration variable VarConditionalReconfig. The UE starting to perform the handover is the time when the UE receives a legacy handover command corresponding to the handover procedure.

### Embodiment 2

This embodiment provides another handover information reporting method performed on UE. By means of the method according to this embodiment, in handover information reporting in which UE is configured with a CHO but a CHO procedure has not been performed, the UE may determine, according to whether a target cell of the handover is a candidate cell in a CHO configuration stored thereby, to set time information related to the CHO to be a corresponding value, so as to provide more precise handover information to the network side.

For a successful handover scenario, if UE is configured with a CHO, the value of first time information in an SHR is set by the UE according to the following method:
determining, by the UE, whether a target cell of a handover procedure is a candidate cell in a CHO configuration VarConditionalReconfig stored thereby, and if the target cell of the handover procedure is a candidate cell in the CHO configuration VarConditionalReconfig stored thereby, setting, by the UE, the first time information to be the time elapsed between the UE receiving a corresponding latest CHO configuration including the candidate cell and the UE starting to perform the handover; if the target cell of the handover procedure is a candidate cell in the CHO configuration VarConditionalReconfig stored by the UE, setting, by the UE, the first time information to be the time elapsed between the UE receiving a latest CHO configuration including a candidate cell having the best signal quality and the UE starting to perform the handover.

Preferably, when the above method of setting the first time information is applicable to scenario 2 described above, before the UE sets the time information, the method further includes determining, by the UE, that the handover is not performed due to execution of a CHO. That is, the handover is a legacy handover.

For a handover failure scenario, if UE is configured with a CHO, the value of second time information in RLF-report is set by the UE according to the following method:
determining, by the UE, whether a target cell of a handover procedure is a candidate cell in a CHO configuration VarConditionalReconfig stored thereby, and if the target cell of the handover procedure is a candidate cell in the CHO configuration VarConditionalReconfig stored thereby, setting, by the UE, the second time information to be the time elapsed between the UE receiving a corresponding latest CHO configuration including the candidate cell and the UE starting to perform the handover; if the target cell of the handover procedure is not a candidate cell in the CHO configuration VarConditionalReconfig stored by the UE, setting, by the UE, the second time information to be the time elapsed between the UE receiving a latest CHO configuration including a candidate cell having the best signal quality and the UE starting to perform the handover.

Preferably, when the above method of setting the second time information is applicable to scenario 4 described above, before the UE sets the time information, the method further includes determining, by the UE, that the handover is not performed due to execution of a CHO. That is, the handover is a legacy handover.

For a radio link failure scenario (e.g., scenario 3 described above), if UE is configured with a CHO, the value of second time information in RLF-report is set by the UE according to the following method:
setting, by the UE, the second time information to be the time elapsed between the UE receiving the latest CHO configuration including the candidate cell having the best signal quality and the UE detecting the RLF.

The UE being configured with a CHO may also be expressed as the UE having a stored CHO configuration. The target cell of the handover being one among conditional handover candidate cells means that a cell identifier of the target cell is identical to a cell identifier of a candidate cell included in a synchronized reconfiguration information element reconfigurationWithSync in a MasterCellGroup information element in a stored conditional reconfiguration variable VarConditionalReconfig. The UE starting to perform the handover is the time when the UE receives a legacy handover command corresponding to the handover procedure.

Preferably, the candidate cell having the best signal quality refers to a candidate cell having the best measurement result among the configured conditional handover candidate cells. The measurement result may be an RRM measurement result for indicating link quality, such as reference signal receiving power (RSRP), reference signal receiving quality (RSRQ), a signal to interference plus noise radio (SINR), or a received signal strength indication (RSSI). Optionally, the measurement result is a latest measurement result acquired when handover execution is started, or a latest measurement result acquired when a handover succeeds or a handover failure is detected. In scenario 3, the measurement result is a latest measurement result acquired during an RLF.

Optionally, the corresponding latest CHO configuration including the candidate cell is not used to release the CHO configuration of the candidate cell. That is, in the corresponding latest CHO configuration including the candidate cell, a CHO configuration identifier CondReconfigId corresponding to the candidate cell is not included in a conditional reconfiguration release list condReconfigToRemoveList. Alternatively, in the corresponding latest CHO configuration including the candidate cell, the CHO configuration identifier CondReconfigId corresponding to the candidate cell is included in a conditional reconfiguration addition and modification list condReconfigToAddModList.

Optionally, the CHO configuration including the candidate cell having the best signal quality is not used to release the CHO configuration of the candidate cell having the best signal quality. That is, in the corresponding latest CHO configuration including the candidate cell having the best signal quality, a CHO configuration identifier CondReconfigId corresponding to the candidate cell having the best signal quality is not included in a conditional reconfiguration release list condReconfigToRemoveList. Alternatively, in the corresponding latest CHO configuration including the candidate cell having the best signal quality, the CHO configuration identifier CondReconfigId corresponding to the candidate cell is included in a conditional reconfiguration addition and modification list condReconfigToAddModList.

### Embodiment 3

This embodiment provides still another handover information reporting method performed on UE. By means of the method according to this embodiment, in handover information reporting in which UE is configured with a CHO but a CHO procedure has not been performed, the UE may determine, according to whether a target cell of the handover is a candidate cell in a CHO configuration stored thereby, to set time information related to the CHO to be a corresponding value, so as to provide more precise handover information to the network side.

For a successful handover scenario, if UE is configured with a CHO, the value of first time information in an SHR is set by the UE according to the following method:
determining, by the UE, whether a target cell of a handover procedure is a candidate cell in a CHO configuration VarConditionalReconfig stored thereby, and if the target cell of the handover procedure is a candidate cell in the CHO configuration VarConditionalReconfig stored thereby, setting, by the UE, the first time information to be the time elapsed between the UE receiving a corresponding latest CHO configuration including the candidate cell and the UE starting to perform the handover; if the target cell of the handover procedure is not a candidate cell in the CHO configuration VarConditionalReconfig stored by the UE, skipping, by the UE, recording of the first time information.

Preferably, when the above method of setting the first time information is applicable to scenario 2 described above, before the UE sets the time information, the method further includes determining, by the UE, that the handover is not performed due to execution of a CHO. That is, the handover is a legacy handover.

For a handover failure scenario, if UE is configured with a CHO, the value of second time information in RLF-report is set by the UE according to the following method:
determining, by the UE, whether a target cell of a handover procedure is a candidate cell in a CHO configuration VarConditionalReconfig stored thereby, and if the target cell of the handover procedure is a candidate cell in the CHO configuration VarConditionalReconfig stored thereby, setting, by the UE, the second time information to be the time elapsed between the UE receiving a corresponding latest CHO configuration including the candidate cell and the UE starting to perform the handover; if the target cell of the handover procedure is not a candidate cell in the CHO configuration VarConditionalReconfig stored by the UE, skipping, by the UE, recording of the second time information.

Preferably, if the above method of setting the second time information is applicable to scenario 4 described above, before the UE sets the time information, the method further includes determining, by the UE, that the handover is not performed due to execution of a CHO. That is, the handover is a legacy handover.

For a radio link failure scenario (e.g., scenario 3 described above), the UE does not record the second time information. The second time information refers to the time between the UE receiving an RRC message including a CHO configuration and the detection of the link failure.

The UE being configured with a CHO may also be expressed as the UE having a stored CHO configuration. The target cell of the handover being one among conditional handover candidate cells means that a cell identifier of the target cell is identical to a cell identifier of a candidate cell included in a synchronized reconfiguration information element reconfigurationWithSync in a MasterCellGroup information element in a stored conditional reconfiguration variable VarConditionalReconfig. The UE starting to perform the handover is the time when the UE receives a legacy handover command corresponding to the handover procedure.

Optionally, the corresponding latest CHO configuration including the candidate cell is not used to release the CHO configuration of the candidate cell. That is, in the corresponding latest CHO configuration including the candidate cell, a CHO configuration identifier CondReconfigId corresponding to the candidate cell is not included in a conditional reconfiguration release list condReconfigToRemoveList. Alternatively, in the corresponding latest CHO configuration including the candidate cell, the CHO configuration identifier CondReconfigId corresponding to the candidate cell is included in a conditional reconfiguration addition and modification list condReconfigToAddModList.

### Embodiment 4

In this example, user equipment according to the present disclosure is described. FIG. 3 shows a block diagram of user equipment (UE) according to the present invention. As shown in FIG. 3, user equipment (UE) 30 includes a processor 301 and a memory 302. The processor 301 may include, for example, a microprocessor, a microcontroller, an embedded processor, and the like. The memory 302 may include, for example, a volatile memory (such as a random access memory (RAM)), a hard disk drive (HDD), a non-volatile memory (such as a flash memory), or other memories, etc. The memory 302 stores program instructions. When run by the processor 301, the instructions can perform the above handover information reporting method described in detail in the present invention.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. A person skilled in the art could make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by reading programs recorded on the recording medium and executing the programs by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1. (canceled)

2. (canceled)

3. User Equipment (UE), comprising:
a processor; and
a memory in electronic communication with the processor, wherein instructions stored in the memory are executable to:
if the UE detects a Radio Link failure (RLF) and has stored therein a conditional handover configuration, set time information in a RLF report to a time that has elapsed between reception of a latest conditional handover configuration and the detection of the RLF.

4. A reporting method of User Equipment (UE), comprising:
if the UE detects a Radio Link failure (RLF) and has stored therein a conditional handover configuration, setting time information in a RLF report to a time that has elapsed between reception of a latest conditional handover configuration and the detection of the RLF.

5. A base station apparatus, comprising:
a processor; and
a memory in electronic communication with the processor, wherein instructions stored in the memory are executable to:
transmit a conditional handover configuration to User Equipment (UE), thereby causing the UE to:
store the conditional handover configuration; and
if the UE detects a Radio Link failure (RLF), set time information in a RLF report to a time that has elapsed between reception of a latest conditional handover configuration and the detection of the RLF.
